(19) United States
(12) Patent Application Publication
(10) Pub. No.: US 2008/0226411 A1
(43) Pub. Date: Sep. 18, 2008

(54) DUAL TORQUE SETTING TENSION CONTROL FASTENER

(76) Inventor: Alistair N. McKinlay, Redondo Beach, CA (US)

Correspondence Address: STEVE M CLEMMONS, 33150 SCHOOLCRAFT, SUITE 207, LIVONIA, MI, 48150, US

(21) Appl. No.: 11/687,076

(22) Filed: Mar. 16, 2007

(51) Int. Cl. F16B 31/00; B60B 7/06; F16B 13/04

(52) U.S. Cl. 411/2; 301/35.621; 411/43

(57) ABSTRACT

A tension control fastener having a cylindrical shank having a pair of adjacent breakaway sections at one end. The outermost breakaway section engages an installation tool and shears off from the fastener at a first lower predetermined amount of torque, while the inner breakaway section shears off from the fastener at a second higher predetermined amount of torque.

### FIELD OF THE INVENTION

This invention is related to threaded mechanical fasteners and more particularly to tension control wheel bolts and studs.

### BACKGROUND AND BRIEF SUMMARY OF THE INVENTION

The purpose of tightening bolts (for example, on lug nuts when attaching a wheel to a hub) is to create tension in the bolt or stud. This tension, in turn, creates clamping forces that hold the different pieces together.

The clamping force is actually friction at the interface that restricts movement of the joined surfaces relative to one another. Since clamping force is impractical to measure accurately in the field, torque of the fasteners is measured to approximate the desired clamping force.

Tightening vehicle wheel nuts to their specified torque is extremely important. When a wheel nut is under tightened, the wheel is loose which can damage the wheel, stud and wheel hub and can result in wheel loss during vehicle operation.

One cause of wheel failure is due to an installer's improper application of the correct amount of torque on the wheel nuts. This may result from inattention or to mis-calibrated tools. It is therefore desirable to eliminate the likelihood of misapplied torque with a fastener that provides immediate visual evidence that the fastener is tightened to the correct amount of torque.

Once a tire and wheel assembly has been installed on a vehicle, a period of “settling-in” occurs where the clamped/bolted assembly loses some clamp load. This clamp loss is often due to dust, dirt, paint and/or corrosion on wheel faces, nuts and stud threads settling or moving during operation. The amount of clamp loss is dependent upon the condition of the components, the method of installation used, the number of times the wheels have been installed using the same fasteners, the amount and condition of paint on wheels and the fasteners and lubrication used in the installation process.

Even new wheels and fasteners will lose clamp load. New components can lose torque as a result of loss or compression of fastener coatings on the working surfaces of the hub, brake drum, and disc wheels. Therefore retorquing is necessary to ensure the proper amount of clamp load is attained to keep the tire and wheel assembly safely coupled to the vehicle. Normally, it is recommended in the heavy-trucking industry that wheel nuts be retorqued after 50-100 miles of driving to account for this settling in.

This requisite retorquing will also benefit from a “fool-proof” system of visual inspection that the retorqued fasteners have been set to the desired level.

Currently, tension control bolts are used in the construction of static structures using structural steel framing. These prior art tension control bolts include a bolt and nut that provide immediate visual feedback to an installer that the fastener has been set to the correct torque setting. The bolt includes a breakaway section at the end of the threaded portion of the bolt. A groove is formed in the bolt between the threads and the breakaway section. The breakaway section is designed to break off, at the reduced diameter groove, when a tension above a pre-determined design level is induced in the bolt during installation. An installation tool, commonly referred to as a shear wrench, grips the breakaway section with a conforming chuck and tightens the nut until the breakaway sections twists off at the groove. These prior art tension control bolts, being designed for static structure construction that do not suffer from the settling-in of vehicle fasteners, have the inherent drawback that after their initial installation they do not provide a means for visually ensuring that a retorquing operation has properly occurred.

The broad purpose of the present invention is to provide a tension control fastener that includes at least two breakaway sections that twist free from the fastener at a predetermined amount of torque. The tension control fastener is preferably adapted as a wheel nut or stud having a threaded shank that receives a nut. The end of the threaded shank includes the multiple breakaway sections which are adjacent and axially coextensive to each other along the fastener's shank.

One advantage of the present invention is that it ensures that the fastener is tightened to a first predetermined torque level and is then able to ensure that the same fastener is tightened to a second predetermined torque level.

Another advantage of the present invention is that it provides a user with a fool-proof visual reference that the fastener has been tightened to a first predetermined torque level.

Still another advantage of the present invention is that it provides a user with a fool-proof visual reference that the fastener has been re-tightened to a second predetermined torque level.

Still further objects and advantages of the invention will become readily apparent to those skilled in the art to which the invention pertains upon reference to the following detailed description.

### BRIEF DESCRIPTION OF THE DRAWINGS

The description refers to the accompanying drawings in which like reference characters refer to like parts throughout the several views, and in which:

FIG. 1 illustrates a tension control fastener embodying the invention;

FIG. 2 is a view through line 2 of FIG. 1 illustrating a splined breakaway section;

FIG. 3 shows the tension control fastener with one of its breakaway sections removed;

FIG. 4 shows the tension control fastener with both of its breakaway sections removed;

FIG. 5A-E illustrate the steps involved with the tension control fastener to couple a pair of wheels to a wheel hub;

FIG. 6 illustrates an alternate tension control fastener embodying the invention;

FIG. 7 shows an alternate embodiment of the splined breakaway sections;

FIG. 7A is a view through line A of FIG. 7 showing the differing number of splines in each breakaway section;

FIG. 8 shows another alternate embodiment of the splined breakaway sections;

FIG. 8B is a view through line B of FIG. 8 showing the splines of the inner and outer breakaway sections clocked at different angles about the longitudinal axis;

FIG. 9 shows still another alternate embodiment of the splined breakaway sections; and

FIG. 9C is a view through line C of FIG. 9 showing the different depths of the splines in the breakaway sections.

### DETAILED DESCRIPTION OF THE INVENTION

FIGS. 1-4 show a tension control fastener 10 having a threaded bolt 12 and a complementary nut 14. In one embodiment, bolt 12 is generally presented as a wheel bolt and nut 14 as a safety nut, such as the safety nut described in U.S. Pat. No. 5,626,449 issued to the present inventor, incorporated herein by reference.

As shown best in FIG. 1, bolt 12 includes a cylindrical shank 16 and an enlarged head 18. In the wheel bolt embodiment illustrated in FIGS. 1-5, the shank includes a hub-engaging section or body 20 and a threaded portion 22 that runs along a length of shank 16. Body 20 preferably includes a plurality of slightly raised longitudinally aligned ridges or ribs 21.

In this embodiment, head 18 is located at one end of the shank and body 20 is adjacent to head 18. In other non-limiting embodiments, the body 20 may be eliminated and the threaded portion may run along the entire length of the shank.

Bolt 12 differs from conventional wheel bolts in that the end 23 opposite to bolt head 18 includes a pair of breakaway sections 24 and 26. Each breakaway section includes a plurality of longitudinally running ribs or splines 27 that are gripped by a specially designed shearing chuck 28 of an installation tool 30 (shown in FIGS. 5B-5E), such as a commercial shear wrench. As shown in FIG. 2, in one embodiment, twelve splines 27 define the outer surface of each breakaway section. It should be appreciated, however, that substantially any number of splines or their equivalent structure may be used to mate with a chuck 28.

Each breakaway section 24, 26 includes an adjacent breakaway groove 32, 34. The grooves 32, 34 are formed into the shank such that the grooves present the two narrowest cross-sections of the shank 16. The outermost groove 34 being slightly deeper (i.e., presenting the narrowest section in the shank) than the inner groove 32.

It should be appreciated that the splines 27 shown on the breakaway sections 24, 26 are for illustrative purposes only and that any equivalent gripping surface and complementary shear wrench chuck 28 may be used for the purpose of removably coupling the installation tool to the breakaway sections while a torsional force is applied to the fastener.

In operation, the outermost breakaway section 26 is gripped by shear chuck 28 of installation tool 30. The installation tool mates with and turns the nut 14 relative to bolt 12 (i.e., relative to breakaway section 26). As shown in FIG. 3, when the torque applied to breakaway section 26 relative to nut 14 is greater than a predetermined amount, breakaway section 26 breaks away from shank 16 at groove 34. The sheared away section 26 presents visually identifiable confirmation to the installer that fastener 10 has been torqued to the predetermined level.

The greater depth of groove 34 presents the weakest section along shank 16 and ensures that the torque applied to nut 14 and bolt 12 will cause the outermost breakaway section 26 to break away leaving breakaway section 24 at the end of shank 16.

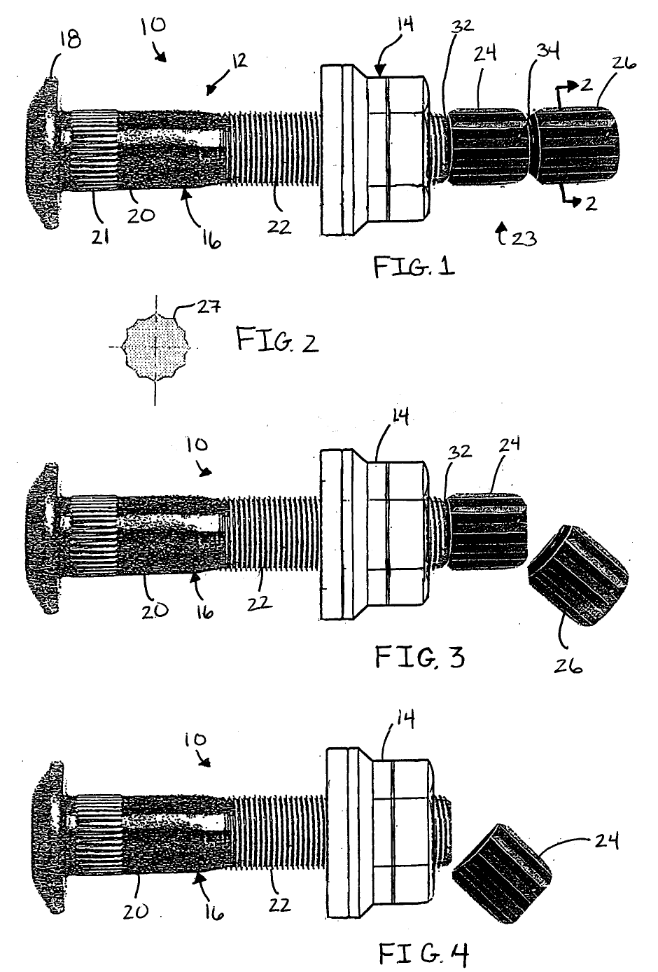

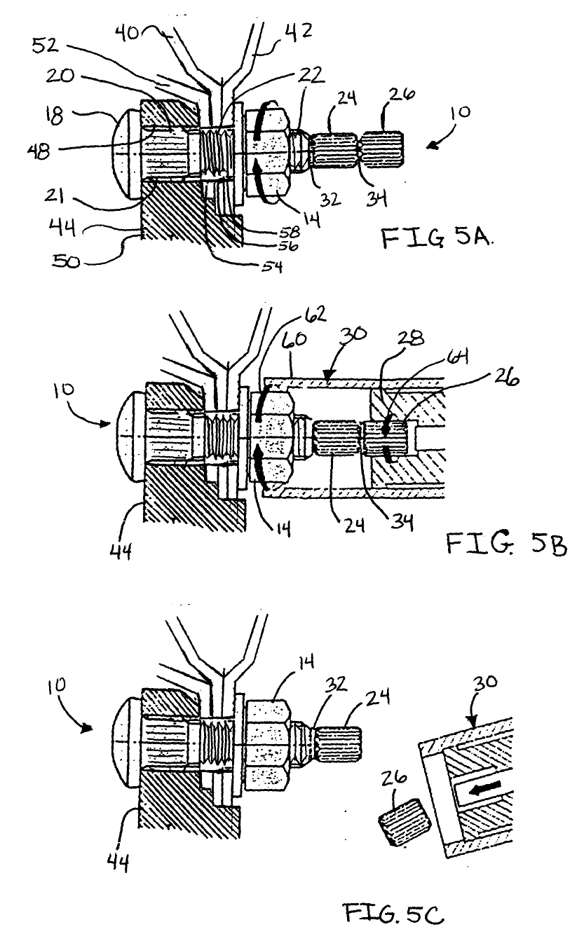

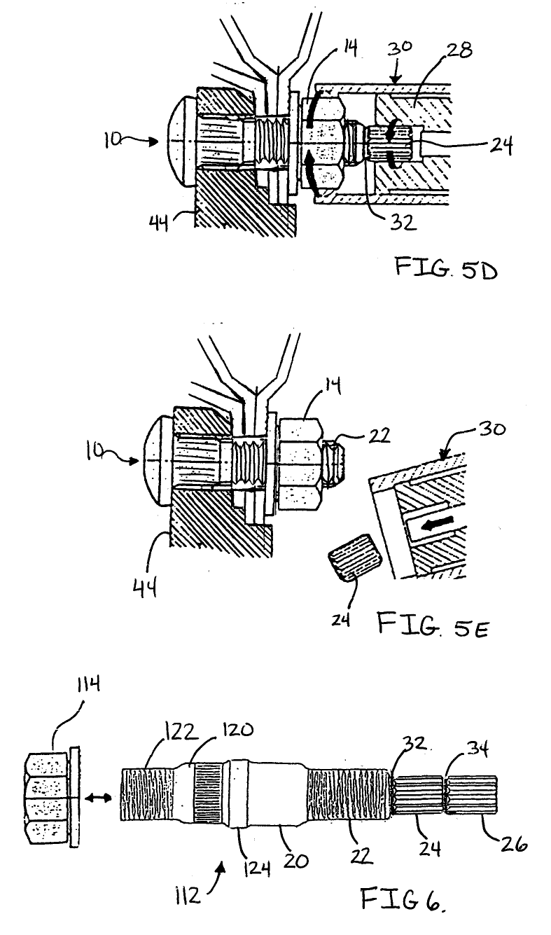

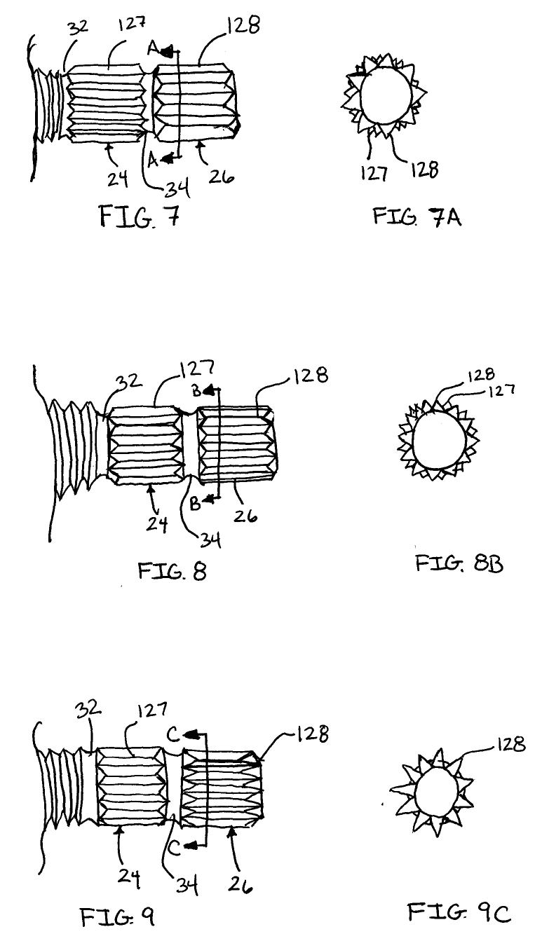

As shown in FIG. 4, the second or inner breakaway section 24 is broken free from shank 16 at groove 32 in substantially the same manner as that described above ensuring that the fastener has been torqued to a second predetermined amount. The newly broken-away section 24 provides quick and accurate visual confirmation that the second predetermined torque level has been achieved.

Referring now to FIGS. 5A-5E, the installation steps of coupling a pair of wheels 40, 42 to a wheel hub 44 with fastener 10 are illustrated. It should be appreciated that in other embodiments only one wheel may be fastened.

Installation begins in FIG. 5A where the ribs 21 in body 20 interferingly mate with a pilot hole 48 formed in hub 44. Head 18 abuts the inner surface 50 of the hub, while shank 16 projects from the opposite side, thereby creating a hub-piloted fastener. Wheels 40, 42 and other wheel components, such as brake drum 52 are sandwiched together such that their respective mounting holes 54, 56, 58 are aligned. Shank 16 is passed through these aligned holes 54-58. Nut 14 is passed concentrically over breakaway sections 24, 26 and is threaded onto threaded portion 22 of the shank. Nut 14 is finger tightened to loosely couple the wheels and brake drum to the hub.

In FIG. 5B, installation tool 30 is pushed over and mated to the fastener 10 with the shear chuck 28 gripping only the splines 27 of outer breakaway section 26 and the forward end 60 of tool 30 having a complementary shape to nut 14 (e.g., a six-point socket). Tool 30 applies a rotational force in the direction of arrow 62 upon nut 14 and applies a resulting torque to breakaway section 26 in the direction of arrow 64.

Once the torque applied to fastener 10 exceeds a predetermined level, breakaway section 26 shears off of the fastener at groove 34, as shown in FIG. 5C. Once breakaway section 26 breaks away from fastener 10 a user immediately knows that the predetermined breakaway torque has been applied to the fastener.

If a user desires to retighten or retorque fastener 10, such as after a “settling-in” period of time, the second or inner breakaway section 24 remains and provides immediate visual feedback confirming that a second retorquing process will exceed a second predetermined torque level as designed into the fastener 10.

FIGS. 5D-5E, show the steps of retorquing a fastener 10 that has already been tightened according to the steps shown in FIGS. 5A-5C, where the outer breakaway section 26 has been sheared away.

In FIGS. 5D and 5E, an installation tool, such as a shear wrench, is mated to fastener 10 over nut 14 and the splines 27 of breakaway section 24. Once both the nut and section 24 are seated within the installation tool, a tightening torque is applied to fastener 10 and when a predetermined amount of torque has been applied, breakaway section 24 breaks away from shank 16 at groove 32. At this time the shear wrench is removed from the fastener and the user can visually see that the fastener 10 has been tightened to the second predetermined amount of torque as evidenced by the shorn away breakaway section 24.

Referring now to FIG. 6, an alternate embodiment of the invention is shown. In this embodiment, the wheel bolt configuration of bolt 12 is replaced with a shoulder stud 112 configuration. As shown, the breakaway sections 24, 26, threaded portion 22 and body 20 remain substantially the same as in fastener 10. Stud 112 differs from bolt 12 at the other end of the fastener. Where bolt 12 terminates at one end with head 18, stud 112 has another threaded section 122 that threadably receives a second nut 114. Nut 114 replaces the enlarged head 18 and allows for greater adjustment of the fastener.

A second cylindrical body 120 is intermediate to threaded section 118 and body 20. An enlarged annular collar or shoulder 124 is intermediate to the two bodies 20,120 and projects radially from the longitudinal axis of the stud.

It should be appreciated that the bolt 12 and stud 112 provided herein are exemplary and that various configurations of threaded fasteners may be used with the dual breakaway sections 24, 26.

As shown in FIGS. 7-9, other embodiments of the invention are illustrated and in these embodiments, the longitudinal splines 127 of the inner breakaway section 24 differ from splines 128 of the outermost breakaway section 26 to prevent the shear chuck 28 from accidentally gripping the inner breakaway section 24 during an initial installation (i.e., during the steps shown in FIGS. 5B-5C). It should be appreciated that each of these embodiments, either alone or in combination with each other ensure that a shear chuck 28 will not matingly receive both breakaway sections 24, 26.

As shown in FIGS. 7 and 7A, splines 127 and 128 may differ in the number of splines around the sections 24, 26, preferably with the outermost section 26 having fewer splines 128 than the inner section 24 such that a shear chuck 28 adapted to grip outer splines 128 will not matingly receive the inner splines 127.

FIGS. 8 and 8B show that the splines 127 and 128 found on the two breakaway sections 24, 26 aligned radially around shank at different angles. In this manner, a shear chuck 28 will not matingly receive both breakaway sections 24, 26.

FIGS. 9 and 9C provide that the splines may be formed at different depths, preferably the outermost splines 128 being deeper into shank 16 such that a corresponding shear chuck will not mate with the shallower splines 127.

While the present invention has been described with particular reference to various preferred embodiments, one skilled in the art will recognize from the foregoing discussion and accompanying drawing and claims that changes, modifications and variations can be made in the present invention without departing from the spirit and scope thereof as defined in the following claims.

Having described my invention, I claim:

1. A tension control fastener comprising:
an elongated shank having an enlarged head proximate to a first end, wherein the other end of the shank includes a pair of adjacent breakaway sections, said shank includes a threaded portion between said head and the innermost breakaway section; and
a nut that is threadably received by said threaded portion;
wherein said outermost breakaway section breaks off from said shank at a first torsional force and said innermost breakaway section breaks off from said shank at a second torsional force, and wherein said second torsional force is greater than said first torsional force.

2. The tension control fastener of claim 1, wherein the breakaway sections are separated by a first groove formed in the shank and the innermost breakaway section is separated from the threaded portion by a second groove.

3. The tension control fastener of claim 2, wherein the first groove is formed deeper into the shank than the second groove.

4. The tension control fastener of claim 1, wherein the shank further comprises a cylindrical body surface between the head and threaded portion.

5. The tension control fastener of claim 4, wherein said body surface includes a plurality of radially projecting ribs, each rib running parallel to a longitudinal axis of said shank.

6. The tension control fastener of claim 1, wherein said elongated shank includes a second threaded portion and an annular shoulder disposed between the two threaded portions, and wherein said head is a second nut that is removably coupled to said second threaded portion.

7. The tension control fastener of claim 1 wherein both of said breakaway sections include engagement means that cooperate with a tool to apply said torsional forces to the breakaway section.

8. The tension control fastener of claim 7 wherein said engagement means are splines formed longitudinally along the breakaway sections.

9. A tension control wheel stud suited to couple a vehicle wheel to a wheel hub through aligned apertures in the wheel and hub, comprising:
an elongated shank having head means proximate to a first end, said head means abutting said hub as said shank passes through said aligned apertures, and the other end of the shank includes a pair of adjacent breakaway sections, said shank includes a threaded portion between said head and the innermost breakaway section; and
nut means that is threadably received by said threaded portion and couples the wheel to the hub;
wherein said outermost breakaway section breaks off from said shank at a first torsional force and said innermost breakaway section breaks off from said shank at a second torsional force that is greater than said first torsional force.

10. The tension control wheel stud of claim 9, wherein the breakaway sections are separated by a first groove formed in the shank and the innermost breakaway section is separated from the threaded portion by a second groove.

11. The tension control wheel stud of claim 9, wherein the shank further comprises a cylindrical body surface between the head and threaded portion.

12. The tension control wheel stud of claim 11, wherein said bearing surface includes a plurality of radially projecting ribs, each rib running parallel to a longitudinal axis of said shank.

13. The tension control wheel stud of claim 9 wherein both of said breakaway sections include engagement means that cooperate with a tool to apply said torsional forces to the breakaway section.

14. The tension control wheel stud of claim 13 wherein said engagement means are splines formed longitudinally along the breakaway sections.

15. A method of ensuring a fastener is torqued to two desired settings at different times, comprising the steps of:
providing a threaded fastener having at least two adjacent breakaway sections at one end;
fitting a nut to the threaded fastener;
causing the outermost breakaway section to break from the fastener by applying a first amount of torque to the fastener with an installation tool that engages both the nut and the outermost breakaway section; and
causing the next outermost of the remaining breakaway sections to break from the fastener by applying a second rotational force to the nut with an installation tool that engages both the nut and the remaining outermost breakaway section;
wherein the second amount of torque is greater than the first amount of torque.

16. The method defined in claim 15 wherein said installation tool does not engage said next outermost breakaway section when said first amount of torque is applied to said fastener.

17. The method defined in claim 15 wherein the step of providing a fastener further includes the step of forming a plurality of splines along each of said breakaway sections, and wherein said installation tool engages said splines.

18. The method defined in claim 15 wherein the step of causing the remaining outermost breakaway section to break from the fastener is performed after a settling-in period where the nut may loosen from the fastener.
